(19) United States
(12) Patent Application Publication
(10) Pub. No.: US 2014/0100858 A1
(43) Pub. Date: Apr. 10, 2014

(54) System and Method for Identification of Risk Indicators Based on Delays in Answering Survey Questions

(71) Applicants: ROBERT BOSCH HEALTHCARE SYSTEMS INC., Palo Alto, CA (US); ROBERT BOSCH GMBH, Stuttgart (DE)

(72) Inventor: Michael Grollmuss, Baltmannsweiler (DE)

(73) Assignees: ROBERT BOSCH GMBH, Stuttgart (DE); ROBERT BOSCH HEALTHCARE SYSTEMS INC., Palo Alto, CA (US)

(21) Appl. No.: 13/645,166

(22) Filed: Oct. 4, 2012

(51) Int. Cl. G06Q 50/22

(52) U.S. Cl. 705/2

(57) ABSTRACT

In a telehealth system, a telehealth terminal presents a survey question to a patient. The patient enters a response to the survey question with the telehealth terminal. The telehealth terminal identifies an elapsed time between the presentation of the survey question and the entry of the response. A telehealth analysis system identifies a deviation between the elapsed time and a history of elapsed times taken to answer the survey question. The telehealth analysis system identifies a risk factor associated with the patient when the elapsed time deviates from the history of elapsed times.

### TECHNICAL FIELD

This disclosure relates generally to the fields of medical information and patient management, and, more particularly, to methods and systems for identifying risk factors in patients who fill out survey forms in a telehealth system.

### BACKGROUND

The fields of telemedicine and home healthcare have experienced strong growth in recent years. In a telemedicine system, a patient is geographically removed from the presence of a doctor or other healthcare provider. For example, the patient could be at home instead of on site at a healthcare facility. Telemedical devices enable the healthcare provider to monitor the health status of a patient and potentially diagnose and treat some medical problems without the need for the patient to travel to the healthcare facility. The use of telemedical systems has the potential to reduce the cost of healthcare, and to improve the quality of healthcare through increased patient monitoring.

Various known telemedicine systems provide a device to a patient that enables the patient to transmit medical data to a doctor or healthcare provider. Some devices are configured to record biosignals, such as heart rate, blood pressure, and respiration rates, and transmit data of the recorded biosignals to a database for later review. Other telemedicine systems enable remote visits between a patient and a healthcare provider and also provide real time medical data to the provider during the visits.

Some telehealth systems also generate periodic surveys asking various questions to the patient regarding symptoms or the well-being of the patient. A telehealth analysis system generates the surveys automatically and the responses to the surveys are stored in a centralized database. Depending upon the course of treatment, a telehealth terminal prompts the patient to respond to a survey one or more times per day, or more infrequently on a weekly or monthly basis. A telehealth system can perform automated analysis of the responses to monitor the medical condition of the patient and evaluate the effectiveness of the medical treatment. A doctor or other healthcare provider can also review the responses to the surveys. While the contents of responses to survey questions are useful in providing telemedical care to the patient, additional information about the health of the patient can also be useful. Requiring the patient to answer different survey questions or to use direct medical monitoring devices can be cumbersome and increase the cost of telehealth treatments. Consequently, improvements to the analysis of data collected from the patient to improve the accuracy of identifying the medical condition of the patient would be beneficial.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure related to systems and methods for identification of a risk factor in a patient have been developed. The method includes presenting a first survey question to a patient with an audio-visual output device, recording a first response to the first survey question with an input device, identifying a first elapsed time between presenting the first survey question and the recording of the response to the first survey question with a timer, identifying with a processor executing programmed instructions stored in a memory operatively connected to the processor a first deviation between the identified first elapsed time and a parameter corresponding to a plurality of previously identified elapsed times taken for the patient to respond to the first survey question, identifying with the processor a risk factor associated with the patient in response to the identified first deviation exceeding a predetermined threshold, and generating an output with the processor to inform at least one of the patient and a healthcare provider of the identified risk factor.

In another embodiment, a method for identification of a risk factor in a patient has been developed. The method includes presenting a plurality of survey questions to a patient with an audio-visual output device, recording a response to each of the plurality of survey questions with an input device, identifying a total elapsed time between presenting a first one of the plurality of survey questions and recording a response to a final one of the plurality of survey questions with a timer, identifying with a processor executing programmed instructions stored in a memory operatively connected to the processor a deviation between the total elapsed time and a parameter corresponding to a plurality of previously identified elapsed times taken for the patient to respond to the plurality of survey questions, identifying with the processor a risk factor associated with the patient with the processor in response to the identified deviation exceeding a predetermined threshold, and generating an output with the processor to inform at least one of the patient and a healthcare provider of the identified risk factor.

In another embodiment, a telehealth system that identifies a risk factor in a patient has a been developed. The telehealth system includes a telehealth terminal and a telehealth analysis system. The telehealth terminal includes an audio-visual output device, an input device, a network device, a timer, and a controller operatively connected to the audio-visual output device, the input device, the network device, and the timer. The controller is configured to receive a first survey question from the telehealth analysis system with the network device, present the first survey question to a patient with the audio-visual output device, record a first response to the first survey question from the patient with the input device, identify a first elapsed time between presenting the first survey question to the patient and recording the first response from the patient, and send the first response and the first elapsed time to the telemedical analysis system with the network device. The telehealth analysis system includes another network device, a survey response database, and a processor operatively connected to the other network device and the survey response database. The processor is configured to receive the first response and the first elapsed time from the telehealth terminal with the other network device, identify a parameter corresponding to a first plurality of previously identified elapsed times taken for the patient to respond to the first survey question from the survey response database, identify a first deviation between the elapsed time and the parameter, identify a risk factor associated with the patient in response to the identified first deviation exceeding a predetermined threshold, and send a notification of the risk factor associated with the patient to at least one of the telehealth terminal and a terminal of a health care provider with the other network device.

### BRIEF DESCRIPTION OF THE DRAWINGS

FIG. 1 is a schematic diagram of a telehealth system that generates surveys for a patient and receives responses to survey questions from the patient.

FIG. 2 is a block diagram of a process for identifying risk indicators based on the elapsed time taken for a patient to respond to questions presented during surveys in a telehealth system.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such development effort might be complex and time consuming, but would nevertheless be a routine undertaking of design, fabrication, and manufacture for those of ordinary skill having the benefit of this disclosure.

The term “telemedicine” as used herein refers to a form of medicine in which a patient and healthcare provider electronically communicate with one other to enable the patient, who is not located in a healthcare facility, to receive medical treatment from the healthcare provider. The terms “telemedical device” or “telehealth device” as used herein refer to any device that is configured to electronically transmit and/or receive data pertaining to a telemedicine treatment received by a patient from a healthcare provider practicing telemedicine on the patient. A telehealth device is one example of a more general category of medical devices, which include any device having diagnostic and/or therapeutic uses, such as respirators, pace makers, blood sugar testing devices, inhalators, heart monitors, and the like.

The term “medical data” as used herein refers to any data relevant to medical treatment of a patient. The term “medical record” refers to a set of medical data corresponding to a patient. The probability value generated by a probabilistic model described in this document indicates the likelihood that the selected patient will experience a benefit that outweighs a corresponding cost if provided with a telemedical device.

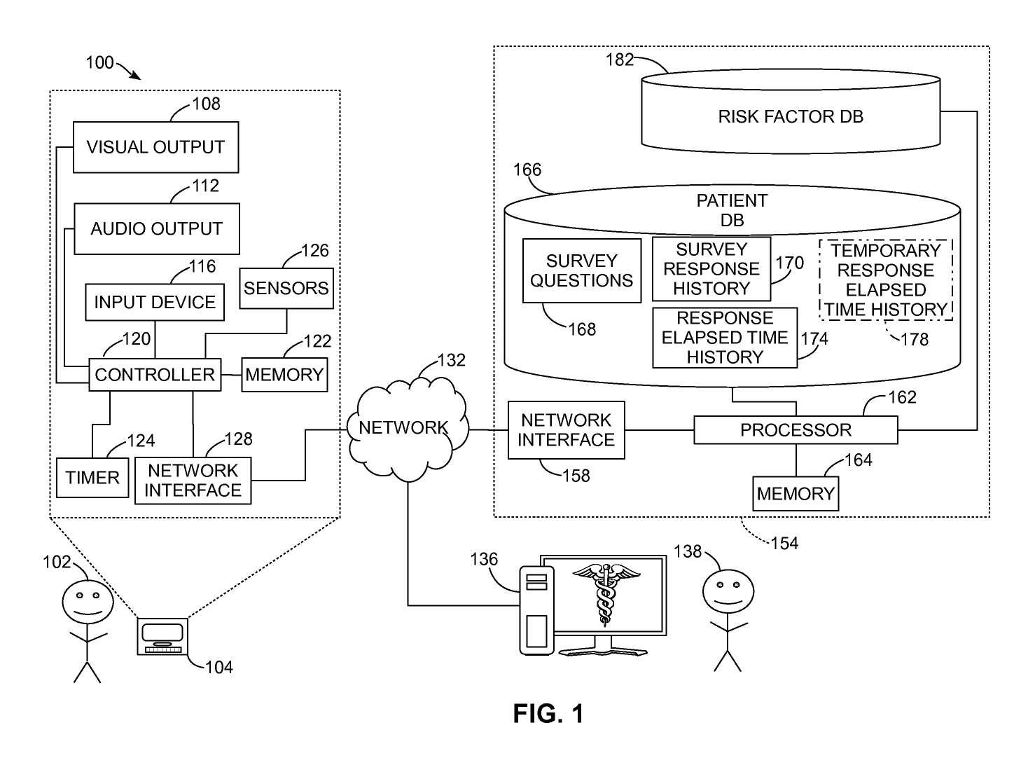

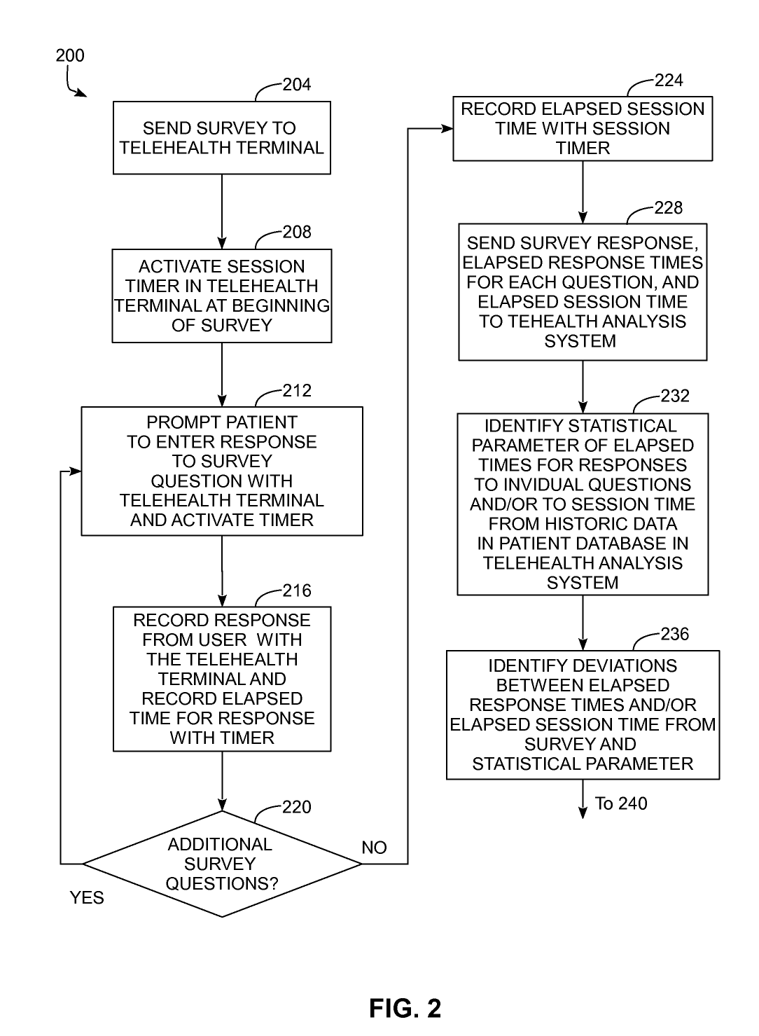

FIG. 1 depicts a telehealth system 100 that provides telemedical treatment to a patient 102. The telehealth system 100 includes a telehealth terminal 104 and a telehealth analysis system 154. The telehealth terminal 104 is communicatively coupled to the telehealth analysis system 154 through a data network 132. In one embodiment, the data network 132 is the Internet, but the telehealth device 104 and telehealth analysis system 154 can communicate through other networks including the public services telephone network (PSTN) or a local area network (LAN).

The telehealth terminal 104 includes a visual output device 108, audio output device 112, input device 116, controller 120, memory 122, timer 124, optional patient sensors 126, and network interface 128. The visual output device displays visual data such as text, graphics, and video to the patient 102. In one embodiment, the visual output is a display monitor such as a liquid crystal display (LCD), organic light-emitting diode display (OLED) or any other visual display device. The audio output 112 emits sounds such as audible instructions, questions, or alerts for the patient 102. In FIG. 1, the audio output includes a loudspeaker that is integrated into the telehealth terminal 104, and alternative embodiments include multiple loudspeakers or output devices that send the audio to headphones or an external sound system. Together, the visual output 108 and audio output 112 are referred to as an “audio-visual output device.” In an alternative embodiment, the audio-visual output device includes only one of the visual output 108 or audio output 112. The input device 116 enables the patient 102 to enter commands and data into the telehealth terminal 104. The input device 116 can include buttons, knobs, dials, keypads, touchpads, pen input pads, or other controls integrated into the telehealth device 104. In another embodiment, the input device 116 is a touchscreen device that is integrated into the visual output 108. In still another embodiment, the input device includes either or both of a microphone and a camera to record spoken input or gestures, respectively, from the patient 102.

In the telehealth terminal 104, the visual output 108, audio output 112, and input device 116 are operatively connected to a controller 120. The controller 120 is a digital processing device such as a microcontroller, microprocessor, field programmable gate array (FPGA), application specific integrated circuit (ASIC) or any other suitable digital processing device. A memory 122 stores programmed instructions that the controller 120 executes during operation of the telehealth terminal 104. The memory 122 also stores data received from the patient 102 and from the telehealth analysis system 154. The memory 122 can include either or both of a volatile memory, such as static or dynamic random access memory (RAM), and a non-volatile memory such as a magnetic disk or flash memory. During operation, the controller 120 generates output signals for either or both of the visual output 108 and the audio output 112.

The controller 120 is additionally coupled to a timer 124. As described in more detail below, the controller 120 sets and resets the timer 124 to generate a measurement of time that elapses between presentation of a survey question to the patient 102 and the entry of a response to the question. In another configuration, the timer 124 identifies the amount of time that elapses as the patient 102 reads a question, and the amount of time taken for the patient 102 to answer the question after the question is read. In some embodiments, the timer 124 can simultaneously measure multiple concurrent elapsed times, such as the total elapsed time to complete a survey and the elapsed time of an individual question in the survey. The timer 124 in FIG. 1 can be a separate timing device or can be integrated into the controller 120. In some embodiments, the timer 124 is either a digital interrupt counter or other timing circuit that is integrated with the controller 120, or is implemented in software in the controller 120 through delay loops or software-based timing methods. Various components in the telehealth terminal 104 can be combined into a single unit referred to as a system on a chip (SoC). For example, the functions of the controller 120, memory 122, timer 124, network interface 128, can be combined in a SoC in the telehealth terminal 104.

The telehealth terminal 104 optionally includes one or more patient sensors 126. The patient sensors 126 are configured to identify information about the state of the telehealth terminal 104 or the patient 102 while the patient 102 uses the telehealth terminal 104. For example, in a handheld embodiment, the telehealth terminal 104 includes one or more accelerometers that identify motion in the telehealth terminal 104 as the patient 102 holds and uses the telehealth terminal 104. The patient sensors 126 also include proximity sensors identify if the patient 102 is near the telehealth terminal 104, and track the hand movements of the patient 102 as the patient 102 operates the input devices 116.

The telehealth terminal 104 is communicatively coupled to the telehealth analysis system 154 with the network interface 128. The network interface 128 is a network device such as a modem, Ethernet adapter, universal serial bus (USB) device, wireless local area network (WLAN) device, wireless wide area network (WWAN) device, or any other networking device that is configured to send and receive data using the network 132. The controller 120 is operatively connected to the network interface 128 to enable communication with the telehealth analysis system 154. Amongst other functions, the controller 120 receives data corresponding to survey questions and transmits data corresponding to responses to survey questions and the elapsed times taken to enter the responses with the network interface 128.

In one embodiment, the telehealth terminal 104 is a self-contained device that is issued to the patient 102 through a healthcare provider. In another embodiment, a personal computer (PC) provides the processor 120 and memory 122. The PC also includes appropriate devices to implement the output devices 108 and 112, input device 116, timer 124, and network interface 128. The processor 120 in the PC executes stored software instructions in memory 122 to operate as a telehealth terminal. In still another embodiment, a mobile electronic device such as a smartphone or tablet device implements the functionality of the telehealth terminal.

The telehealth analysis system 154 includes a network interface 158, processor 162, memory 164, patient database (DB) 166, and risk factor database 182. The processor 162 is a digital processing device such as a microprocessor, microcontroller, field programmable gate array (FPGA), application specific integrated circuit (ASIC) or any other suitable digital processing device. In some exemplary embodiments, the processor 162 includes one or more central processing units (CPUs) in the x86, POWER, SPARC, or ARM families. The memory 164 stores programmed instructions that the processor 162 executes during operation of the telehealth analysis system 154. The memory 164 can include either or both of a volatile memory, such as static or dynamic RAM, and a non-volatile memory such as a magnetic disk or flash memory. The patient database 166 and risk factor database 182 store data corresponding to the patient 102, and typically other patients as well, in one or more non-volatile data storage devices such as a redundant array of independent disks (RAID) configuration having multiple magnetic or solid state storage devices. The data in the patient database 166 and risk factor database 182 can also be cached temporarily in volatile RAM for rapid access during operation of the telehealth analysis system 154. The telehealth analysis system 154 sends and receives data with the network interface 158 to communicate with one or more telehealth terminals, such as the telehealth terminal 104, and with one or more healthcare provider terminals 136

In the telehealth analysis system 154, the patient database 166 stores data corresponding to the patient 102 that the telehealth terminal 104 transmits to the telehealth analysis system 154, and also holds survey questions that are transmitted to the telehealth terminal 104. The patient database 166 stores survey questions 168, a history of responses to the survey questions 170, a history of elapsed time taken to respond to the survey questions 174, and optional temporary elapsed response time data 178. The survey questions 168 contain data corresponding to a series of survey questions that are presented to the patient 102 through the telehealth terminal 104. The survey questions 168 can be stored as text, images, videos, sounds, or any suitable data format for presentation to the patient 102. Survey questions can cover a wide range of topics. Examples of survey questions include general questions related to the well-being of the patient, specific questions related to diagnosed medical conditions and the specific treatment of the patient, and knowledge-building questions that are used to teach medical knowledge to the patient to aid in the telemedical treatment. The patient 102 typically answers the same survey questions multiple times during treatment, although the survey questions 168 can be changed during the course of treatment and the telehealth analysis system 154 sends the updated survey questions to the telehealth terminal 104 through the network 132.

The telehealth analysis system 154 stores the history of responses to survey questions 170 and corresponding history of the elapsed times taken to answer the survey questions 174 in the patient database 166. The response history 170 includes the responses entered to survey questions from the patient 102. The telehealth terminal 104 records the responses and sends the response data, including a time stamp corresponding to when the survey was completed and a patient identifier corresponding to the patient 102, to the telehealth analysis system 154 through the network 132. The telehealth terminal 104 also sends elapsed time data corresponding to either the elapsed time taken to respond to each survey question, the total time taken to respond to the entire survey, or both, to the telehealth analysis system 154 with the survey response data. A temporary history of elapsed response times 178 stores response times that deviate from the history of response times 174 by a sufficient degree to indicate that the patient may be experiencing a medical risk factor. As described in more detail below, the temporary response history 178 stores the response time data from one or more surveys for further analysis by the telehealth analysis system before the response times are stored in the elapsed response time history 174.

In the telehealth analysis system 154, the risk factor database 182 stores data corresponding to one or more risk factors that may be associated with the patient 102. As used herein, the term “risk factor” refers to an identified increase in a likelihood that the patient may experience a medical symptom, complication, side effect, or other negative effect during the course of treatment. A deterioration of the medical condition of the patient 102 can lead to identification of certain risk factors. Additionally, if the patient 102 does not adhere to the course of treatment and recommendations of healthcare providers, then negative effects of previously diagnosed medical conditions can also become more likely. Typically, the responses to survey questions and other medical data about the patient provide data that are used to identify new risk factors and monitor existing risk factors. During operation, the telehealth medical system 154 can also identify one or more risk factors associated with the patient based on the elapsed response times for one or more survey questions that are entered by the patient 102.

The telehealth analysis system 154 can be implemented using a single computing device, such as a server, or a cluster of multiple computing devices in one or more geographic locations. In one configuration, a database cluster hosts the patient database 166 and the risk factor database 182, while the processor 162 is implemented using one or more separate servers. The network interface 158 can include multiple physical network devices to provide redundant network connectivity and improved performance. While FIG. 1 depicts a single patient 102 and telehealth terminal 104, a typical configuration of the telehealth analysis system 154 provides services to multiple telehealth terminals and the telehealth analysis system 154 provides sufficient computing and network resources to serve the telehealth terminals efficiently and with fault-tolerance for reliable operation.

During operation, the telehealth analysis system 154 sends survey question data to the telehealth terminal 104 and receives survey responses from the telehealth terminal 104. A healthcare professional 138 accesses the survey responses using a healthcare provider terminal 136. In one embodiment, the telehealth analysis system 154 implements a web server to provide data to the healthcare professional 138. The healthcare provider terminal 136 can be any of a PC, smartphone, tablet, or other computing device that implements web client software to access the data in the telehealth analysis system 154. In another embodiment, the healthcare professional activates a customized software application installed on the healthcare provider terminal 136 to access the telehealth analysis system 154. As described below, the telehealth analysis system 154 identifies risk factors from the risk factor database 182 that could affect the patient 102 with reference to deviations of the elapsed response time for the patient 102 to answer survey questions. The telehealth analysis system 154 generates alert messages indicating that the patient may be affected by the identified risk factors, and the healthcare provider receives the alerts at the healthcare provider terminal 136. The alerts can be sent to the healthcare provider terminal 136 through various communications channels including electronic mail, text messaging, audio/visual alerts, or by presentation as part of a medical record pertaining to the patient 102 that the healthcare professional reviews during treatment. The healthcare professional 138 can then communicate with the patient 102 to determine the severity of the risk factor and recommend a course of treatment.

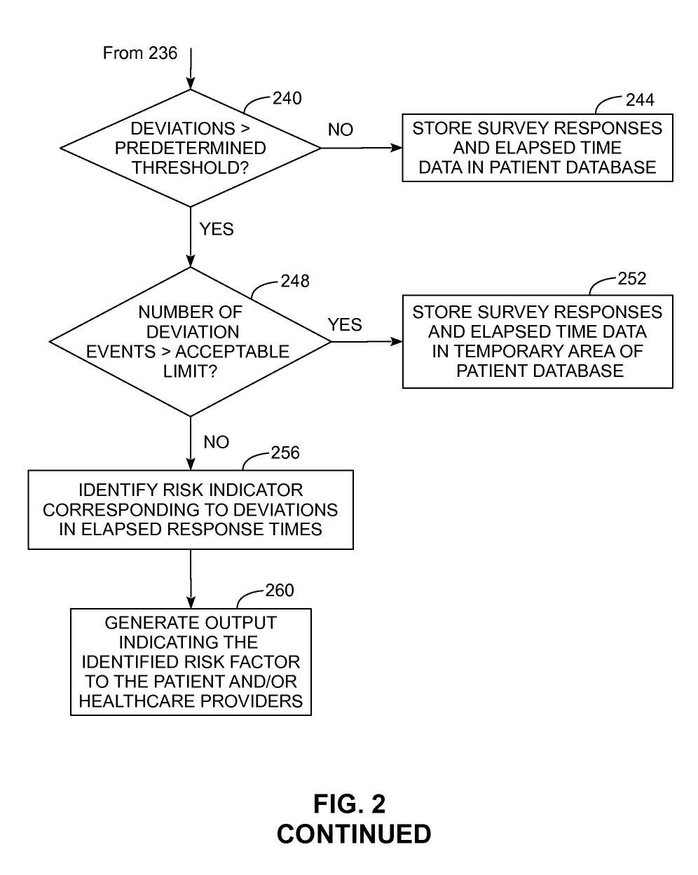

FIG. 2 depicts a process 200 for identifying the elapsed times taken for a patient to complete survey questions in a telehealth system, and for identifying risk factors associated with the patient due to variations in the response times of one or more survey questions. As used in this document, a reference to a process performing or doing some function or event refers to one or more controllers or processors that are configured to implement the process performing the function or event or operating a component to perform the function or event. Process 200 is described with reference to the telehealth system 100 for illustrative purposes.

Process 200 begins by sending survey question data from the telehealth analysis system to the telehealth terminal (block 204). In the telehealth system 100, the telehealth analysis system 154 sends survey question data 168 to the telehealth terminal 104 through the network 132. In one embodiment the telehealth terminal 104 stores the survey questions in the memory 122 for long-term storage. In another embodiment, the survey questions are sent each time that the telehealth terminal 104 presents the survey to the patient 102.

During process 200, the telehealth terminal 104 presents survey questions to the patient 102. The telehealth terminal 104 optionally starts a session timer with the timer 124 at the beginning of the survey (block 208). The session timer records a total elapsed time for the entire survey. In another embodiment, the telehealth terminal 104 does not use a specific timer to measure the total elapsed time for the survey, but instead the terminal 104 or the telehealth analysis system 154 identifies the total time for the survey as a sum of the elapsed times for each of the individual questions in the survey.

Process 200 continues as the telehealth terminal 104 presents a survey question to the patient 102 and prompts the patient to enter a response (block 212). In the processing of block 212, the telehealth terminal 104 also starts a question timer with the timer 124 when the survey question is presented to the patient 102. The patient 102 enters a response to the presented survey question with the input device 116 (block 216). The question timer stops when the patient 102 enters the response, and the telehealth terminal 104 records the elapsed time between presentation of the survey question and the time at which the patient 102 enters the response. The telehealth terminal 104 presents the survey questions in a serial manner. That is to say, the telehealth terminal 104 only presents one survey question at a time to the patient 102, and the patient 102 enters a response before being presented with the next survey question in the series. In another embodiment, the telehealth terminal 104 only measures the total elapsed time for the patient 102 to respond to the entire survey. When only the total elapsed time for the survey is measured, the survey questions can be presented serially or multiple questions can be presented simultaneously. The processing described in blocks 212-216 continues for any additional questions in the survey (block 220). The terminal 104 records an elapsed time taken for the patient 102 to enter each of the responses to the survey questions and stores the survey responses and elapsed times in the memory 122. When the patient 102 has entered responses to all of the questions in the survey, the telehealth terminal 104 stops the session timer, if the session timer was started at the beginning of the session, and records a total elapsed time for the entire survey (block 224).

After the patient 102 completes the survey, the telehealth terminal 104 sends data corresponding to the recorded responses, elapsed times for individual survey questions, and the total elapsed time for the session to the telehealth analysis system (block 228). In the telehealth system 100, the telehealth terminal 104 sends the data through network interface 128, and the telehealth analysis system 154 receives the data with network interface 158. The telehealth terminal 104 and telehealth analysis system 154 can use compression and/or encryption protocols known to the art to compress the data and to ensure the confidentiality of the data when the data are sent through the network 132. In an alternative configuration, the telehealth terminal 104 transmits responses to individual questions and the elapsed time of each question to the telehealth analysis system 154 after the patient 102 enters a response to each survey question instead of sending the data after completion of the survey.

The telehealth analysis system 154 identifies a statistical parameter corresponding to the history of elapsed response times for the patient 102 when responding to survey questions (block 232). Examples of statistical parameters include, but are not limited to, the mean, median, mode, variance, and standard deviation for the elapsed response times recorded for each survey question. The statistical parameter can also be measured for the total elapsed time taken to response to the entire survey, or for groups of two or more questions in the survey. The telehealth analysis system 154 can identify the statistical parameter after receiving the response data from the patient, or can compute the statistical parameter prior to receiving the elapsed time data from the telehealth terminal 104. In some embodiments, the telehealth analysis system 154 applies a discounting or weighting protocol to the historic data. For example, historic elapsed time data from surveys conducted in the previous 60 days receive a greater weighting value than elapsed time data that are older than 60 days. In some situations, the patient 102 becomes more accustomed to responding to survey questions and gains proficiency at responding to knowledge-based questions over time, and the weighting factors take into account changes in the proficiency of the patient 102 over time.

Process 200 continues by identifying a deviation between the elapsed response times that are recorded from the survey responses and the history of elapsed response times for the patient 102 (block 236). As used herein, the term “deviation” refers to a difference between the recorded elapsed time for one or more survey questions and the statistical parameter of the historic data. The telehealth analysis system 154 can further identify a statistical parameter of the elapsed times in the survey response data to identify the deviation. For example, in one configuration the statistical parameter is a set of mean values for changes in the elapsed response times between two or more questions in the survey. The telehealth analysis system identifies the changes in the elapsed response times for the corresponding questions in the survey data and identifies the deviation from the values in the historic data from previously completed surveys. The telehealth analysis system 154 can identify deviations between the statistical parameter and any of the elapsed times for individual survey questions, groups of survey questions, or for the total elapsed time of the survey.

In one embodiment, the telehealth terminal 104 displays a question using the visual output device 108 and prompts the patient 102 to press a button or operate another control to change to a response input prompt. During process 200, the controller 120 identifies the elapsed time between the presentation of the survey question to receiving the signal to change to the response input prompt as a “reading time” that the patient 102 takes to read the question. The “entry time” refers to the elapsed time that begins after the patient reads the question and ending when the patient 102 successfully enters a response. The telehealth terminal 104 optionally identifies the reading time and entry time for one or more survey questions, and the telehealth analysis system 154 identifies deviations between either or both of the reading time and entry time data that are received from the telehealth terminal 104 and historic reading time and entry time data for the patient 102.

In one embodiment, the telehealth terminal 104 prompts the patient 102 to enter a numeric response through multiple presses of an input button to generate the numeric response value. The time of the first depression of the button is used as start time for measuring the total entry time for the response. In another interface display, the telehealth terminal displays a ten-digit numeric entry interface using a touchscreen, and the controller 120 and timer 124 identify hand-eye coordination for the patient 102 with reference to the total elapsed time between entry of the first number and the last number in the response and to the delay between entry of successive numbers in the response.

In some embodiments, the telehealth terminal 104 includes the patient sensors 126 that to track the patient 102 as responses are entered to survey questions. For example, a proximity sensor could identify, when the patient started to bring his or her hand close to input buttons 116 in the telehealth terminal 104. The sensor data from the patient sensors 126 are used to track the movement and coordination of the patient 102 while completing surveys and performing other operations with the telehealth terminal 104. The telehealth terminal 104 transmits sensor data to the telehealth analysis system 154 using the network interface 128.

In process 200, if the identified deviations do not exceed a predetermined threshold from the statistical parameter for the historic survey data (block 240), then the telehealth analysis system 154 stores the survey responses and the elapsed time data in the survey response history 170 and in the response elapsed time history 174 sections of the patient database 166 (block 244). For example, if the standard deviation for response times to a survey question is ±3 seconds, then an elapsed time for the response to the question that is −2 seconds from the mean is within the predetermined threshold. Some variation in the response times to survey questions is expected during the course of treatment.

In some situations, the identified deviation exceeds the predetermined threshold (block 240). In this case, process 200 identifies if the number of deviations has exceeded an acceptable limit (block 248). In some situations, the patient enters a response to one or more survey questions with an elapsed time that is either too small or too great to be within the predetermined threshold of the statistical parameter identified in the historic data. While some deviations can be indicative of one or more risk factors associated with the patient 102, other explanations for deviations can result from incidental events, such as the patient 102 being interrupted during a survey, or the patient 102 accidentally entering a response to a survey question in an abnormally short time. If process 200 identifies that the number of elapsed response times that deviate from the statistical parameter by more than the predetermined threshold is below a predetermined number (block 248), then the elapsed response time data are stored in a temporary section of the patient database (block 252). In the patient database 166, the temporary elapsed response time data 178 stores the elapsed response times temporarily. The elapsed response times are stored in the temporary section 178 until the telehealth analysis system identifies whether or not the deviation in response times is related to a risk indicator for the patient 102. The statistical parameter of the historical elapsed response times are not updated with the elapsed response times held in the temporary storage 178 so that the deviations in the elapsed response time do not influence the identification of the statistical parameter. In another embodiment, the elapsed response time data that deviate from the historical elapsed time data are stored in the elapsed time history 174, but include a flag or other indicator to indicate that the elapsed times are outside the predetermined threshold of the statistical parameter for the remaining historic response time data.

In some cases, process 200 identifies that the deviation between the response times to questions in one or more surveys and the historical data exceed the predetermined threshold during more than an acceptable number of surveys (block 248). In one configuration, the acceptable limit is exceeded when a predetermined number of consecutive surveys having elapsed response times that deviate from the historic response times for the patient is reached, while another configuration can exceed the acceptable limit based on a total number of surveys that deviate from the historic response times for the patient.

Process 200 identifies a risk factor associated with the patient 102 based on the identified deviations in the response times (block 256). In one configuration, the telehealth analysis system 154 identifies one or more risk factors in the risk factor database 182 with reference to the deviation in the response times, and optionally with further reference to previously identified medical conditions that affect the patient and that are stored in the patient database 166. Examples of risk factors include the level of mental focus that a patient is capable of applying to a task, such as responding to survey questions or the hand-eye coordination of the patient when completing the survey.

In one example, if the patient 102 is diagnosed with diabetes, then if the response time to survey questions increases beyond the predetermined threshold, the patient 102 may be suffering from hypoglycemia or another complication related to diabetes that slows the responses to survey questions. Additionally, the telehealth analysis system 154 processes sensor data from the patient sensors 126 in the telehealth terminal 104 to identify risk factors based on the movement of the patient 102. For example, if the sensor data indicate sluggish hand movement or that the patient 102 has difficulty in operating the input controls 116, then the telehealth analysis system 154 can identify corresponding risk factors for the patient 102. The telehealth analysis system 154 identifies a corresponding risk factor from the risk factor database 182. In another situation, the patient 102 may answer survey questions in a very rapid manner, which indicates that the patient is not fully considering the contents of the questions, but is instead simply entering responses to complete the survey quickly. The telehealth analysis system 154 identifies a corresponding risk factor, which indicates that the patient is not following the telemedical treatment regimen.

In some situations, a prolonged reading time or entry time for answering a question is due to an interruption around the patient 102 during the survey instead of the patient 102 being unable to answer the question. The patient sensors 126 in the telehealth terminal 104 include, for example, an accelerometer that generates signals indicating that the telehealth terminal has been placed on a surface and is not moving. If the telehealth terminal 104 does not move for a prolonged time during a survey, the period of inactivity indicates that the patient 102 has set the telehealth terminal 104 aside, and that delays in answering a question may not be indicative of a risk factor.

In another situation, a prolonged reading time followed by a comparatively short entry time taken to answer the question can indicate that the patient 102 lacks the ability to focus on the question being presented, which corresponds to a risk factor in some patients. Alternatively, if the reading time for a survey question is short while the entry time unusually prolonged, then the prolonged entry time may indicate that the patient is experiencing hand-eye coordination problems that delay the entry of the response to the survey question. Thus, during the process 200, the telehealth system 100 is configured to identify deviations in response time with reference to both the reading times and entry times to one or more questions.

Referring again to FIG. 2, if process 200 identifies one or more risk factors affecting the patient 102, the telehealth system 100 generates an output to inform either or both of the patient 102 and a healthcare professional 138 of the risk factor (block 260). For example, the telehealth analysis system 154 sends an alert message to the telehealth terminal 104 to alert the patient 102 to the risk factor. In some embodiments, the telehealth terminal 104 does not display detailed information about the risk factor, but simply suggests that the patient 102 contact the healthcare professional 138 for further discussion. The healthcare professional 138 can review alerts related to the identified risk indicators using the healthcare provider terminal 136. The healthcare professional 138 can then make further decisions, including whether or not the risk indicator is valid. The telehealth analysis system 154 accepts updates from the healthcare professional 154 to confirm either that the identified risk factor is in fact affecting the patient 102, or that the identified risk factor does not affect the patient 102. The telehealth analysis system 102 can use machine learning techniques to incorporate the feedback from the healthcare professional 138 to improve the accuracy of identification of risk indicators for the patient 102 and for other patients during telemedical treatment.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A method for identification of a risk factor in a patient comprising:
presenting a first survey question to a patient with an audio-visual output device;
recording a first response to the first survey question with an input device;
identifying a first elapsed time between presenting the first survey question and the recording of the response to the first survey question with a timer;
identifying with a processor executing programmed instructions stored in a memory operatively connected to the processor a first deviation between the identified first elapsed time and a parameter corresponding to a plurality of previously identified elapsed times taken for the patient to respond to the first survey question;
identifying with the processor a risk factor associated with the patient in response to the identified first deviation exceeding a predetermined threshold; and
generating an output with the processor to inform at least one of the patient and a healthcare provider of the identified risk factor.

2. The method of claim 1, the parameter being a mean of the plurality of previously identified elapsed times.

3. The method of claim 1, the parameter being a median of the plurality of previously identified elapsed times.

4. The method of claim 1, the parameter being a standard deviation of the plurality of previously identified elapsed times.

5. The method of claim 1 further comprising:
presenting a second survey question to the patient with the audio-visual output device in response to the patient responding to the first survey question;
recording a response to the second survey question with the input device;
identifying a second elapsed time between presenting the second survey question and the recording of the response to the second survey question with the timer;
identifying with the processor a second deviation between the identified second elapsed time and the parameter corresponding to a plurality of previously identified elapsed times taken for the patient to answer the second survey question; and
identifying with the processor the risk factor associated with the patient in response to the identified first deviation exceeding the predetermined threshold and the identified second deviation exceeding another predetermined threshold.

6. The method of claim 1 further comprising:
repeatedly presenting the first survey question to the patient with the audio-visual output device after recording the first response to the first survey question;
recording with the processor a plurality of responses to first survey question with the input device, each response in the plurality of responses corresponding to one repetition of the presentation of the first survey question to the patient;
identifying a plurality of elapsed times between the repeated presentations of the first survey question and the corresponding recorded responses to the first survey question with the timer;
identifying with the processor a plurality of deviations between the identified plurality of elapsed times and the parameter corresponding to the plurality of previously identified elapsed times taken for the patient to answer the first survey question; and
identifying with the processor the risk factor associated with the patient in response to the identified first deviation and at least one of the plurality of deviations exceeding the predetermined threshold.

7. The method of claim 1, further comprising:
recording a first input with the input device after presenting the first survey question to the patient;
identifying a reading time for the first survey question with reference to an elapsed time between the presentation of the first survey question and the recording of the first input with the timer;
identifying an entry time for the first survey question with reference to another elapsed time between the recording of the first input and a recording of a second input corresponding to the response to the first survey question with the timer; and
identifying, with the processor, the first deviation of the first elapsed time with reference to at least one of the identified reading time for the first survey question and the identified entry time for the first survey question.

8. A method for identification of a risk factor in a patient comprising:
presenting a plurality of survey questions to a patient with an audio-visual output device;
recording a response to each of the plurality of survey questions with an input device;
identifying a total elapsed time between presenting a first one of the plurality of survey questions and recording a response to a final one of the plurality of survey questions with a timer;
identifying with a processor executing programmed instructions stored in a memory operatively connected to the processor a deviation between the total elapsed time and a parameter corresponding to a plurality of previously identified elapsed times taken for the patient to respond to the plurality of survey questions;
identifying with the processor a risk factor associated with the patient with the processor in response to the identified deviation exceeding a predetermined threshold; and
generating an output with the processor to inform at least one of the patient and a healthcare provider of the identified risk factor.

9. The method of claim 8, the parameter being a mean of the plurality of previously identified elapsed times.

10. The method of claim 8, the parameter being a median of the plurality of previously identified elapsed times.

11. The method of claim 8, the parameter being a standard deviation of the plurality of previously identified elapsed times.

12. The method of claim 8 further comprising:
repeatedly presenting the plurality of survey questions to the patient with the audio-visual output device after recording the plurality of responses;
recording a plurality of responses to each of the repeated presentations of the plurality of survey questions with the input device;
identifying a plurality of total elapsed times between presentation of the first survey question and the corresponding recorded response to the final survey question for each of the repeated presentations of the plurality of survey questions with the timer;
identifying with the processor a plurality of deviations between the identified plurality of total elapsed times and the parameter corresponding to the plurality of previously identified elapsed times taken for the patient to respond to the plurality of survey questions; and
identifying with the processor the risk factor associated with the patient in response to the identified deviation and at least one of the plurality of deviations exceeding the predetermined threshold.

13. A telehealth system comprising a telehealth terminal and a telehealth analysis system, the telehealth terminal further comprising:
an audio-visual output device;
an input device;
a network device;
a timer; and
a controller operatively connected to the audio-visual output device, the input device, the network device, and the timer, the controller being configured to:
receive a first survey question from the telehealth analysis system with the network device;
present the first survey question to a patient with the audio-visual output device;
record a first response to the first survey question from the patient with the input device;
identify a first elapsed time between presenting the first survey question to the patient and recording the first response from the patient; and
send the first response and the first elapsed time to the telemedical analysis system with the network device; and
the telehealth analysis system further comprising:
another network device;
a survey response database; and
a processor operatively connected to the other network device and the survey response database, the processor being configured to:
receive the first response and the first elapsed time from the telehealth terminal with the other network device;
identify a parameter corresponding to a first plurality of previously identified elapsed times taken for the patient to respond to the first survey question from the survey response database;
identify a first deviation between the elapsed time and the parameter;
identify a risk factor associated with the patient in response to the identified first deviation exceeding a predetermined threshold; and
send a notification of the risk factor associated with the patient to at least one of the telehealth terminal and a terminal of a health care provider with the other network device.

14. The telehealth system of claim 13, the parameter being a mean of the plurality of previously identified elapsed times.

15. The telehealth system of claim 13, the parameter being a median of the plurality of previously identified elapsed times.

16. The telehealth system of claim 13, the parameter being a standard deviation of the plurality of previously identified elapsed times.

17. The telehealth system of claim 13, the controller in the telehealth terminal being further configured to:
receive a second survey question from the telehealth analysis system with the network device;
present the second survey question to the patient with the audio-visual output device in response to the patient responding to the first survey question;
record a second response to the second survey question with the input device;
identify a second elapsed time between presenting the second survey question and the recording of the second response with the timer; and
send the second response and the second elapsed time to the telemedical analysis system with the network device; and
the telemedical analysis system being further configured to:
receive the second response and the second elapsed time from the telehealth terminal with the other network device;
identify the parameter corresponding to a second plurality of previously identified elapsed times taken for the patient to respond to the second survey question from the survey response database;
identify a second deviation between the second elapsed time and the parameter corresponding to the second plurality of previously identified elapsed times; and identify the risk factor associated with the patient in response to the identified deviation exceeding the predetermined threshold and the second identified deviation exceeding another predetermined threshold.

18. The telehealth system of claim 13, the controller in the telehealth terminal being further configured to:
receive a plurality of survey questions from the telehealth analysis system with the network device;
present the plurality of survey questions to the patient with the audio-visual output device;
record a plurality of responses to the plurality of survey questions with the input device;
identify a total elapsed time between presenting a first one of the plurality of survey questions and recording a response to a final one of the plurality of survey questions with the timer; and
send the total elapsed time and the plurality of responses to the telehealth analysis system with the network device; and
the processor in the telehealth analysis system being further configured to:
receive the total elapsed time and the plurality of responses from the telehealth terminal with the other network device;
identify the parameter corresponding to a plurality of previously identified total elapsed times taken for the patient to respond to the plurality of survey questions from the survey response database;
identify a deviation between the total elapsed time and the parameter; and
identify the risk factor associated with the patient in response to the identified deviation exceeding the predetermined threshold.

19. The telehealth system of claim 13, further comprising:
a sensor in the telehealth terminal configured to generate sensor data corresponding to movement of the patient;
the controller being operatively connected to the sensor and further configured to:
send data corresponding to the movement of the patient generated with the sensor while the patient operates the input device to the telemedical analysis system with the network device; and
the processor in the telemedical analysis system being further configured to:
identify the risk factor associated with the patient with reference to the data corresponding to the movement of the patient.
